(19) United States
(12) Patent Application Publication
(10) Pub. No.: US 2016/0132219 A1
(43) Pub. Date: May 12, 2016

(54) ENHANCED VIEW TRANSITIONS

(71) Applicant: Microsoft Technology Licensing, LLC, Redmond, WA (US)

(72) Inventors: Han-Yi Shaw, Redmond, WA (US); Michael Kelly Reneer, Seattle, WA (US)

(21) Appl. No.: 14/678,153

(22) Filed: Apr. 3, 2015

Related U.S. Application Data
(60) Provisional application No. 62/076,227, filed on Nov. 6, 2014.

(51) Int. Cl. G06F 3/0484; G06F 3/0482; G06T 13/80; G06F 3/0481

(52) U.S. Cl. CPC G06F 3/04845; G06F 3/0481; G06F 3/0482; G06T 13/80; G06T 2200/24

(57) ABSTRACT

Systems, methods, and software are disclosed herein that enhance the content viewing experience on computing devices having small form factors relative to larger devices. In an implementation, an application detects when a view transition is invoked. When the view transition is invoked, the application initiates a swap animation process to transition from one view of a document to a different view of the document. The application also surfaces floating command components over content in the document in the different view of the document.

### RELATED APPLICATIONS

This application is related to and claims priority to U.S. Provisional Application No. 62/076,227, filed on Nov. 6, 2014, and entitled “Enhanced View Transitions,” which is hereby incorporated by reference in its entirety.

### TECHNICAL BACKGROUND

Many software applications are capable of presenting content in different views. For example, a word processing application may be capable of presenting a document in a draft view, a print view, a layout view, and the like.

When working with such applications on large form factor devices, such as desktop and laptop computers, the formatting of a document remains relatively consistent from one view to another. For example, a bold and italicized word will appear the same in a draft view of a document as in a print view.

Smaller form factor devices present a challenge in this respect, in that the presentation of a document's content sometimes differs greatly from one view to the next. For example, the size, layout, and style of words in a document presented on a smart phone may differ between a fit-to-page view and a fit-to-screen view.

In some cases, the difference may be so great that an end user may become confused and attempt to edit the formatting of the document. However, such attempts can result in unintentional formatting mistakes that were not necessary to begin with.

### OVERVIEW

Provided herein are systems, methods, and software that enhance the content viewing experience on computing devices having small form factors relative to larger devices, although such enhancements are applicable to devices of any form factor.

In an implementation, an application detects when a view transition is invoked. When the view transition is invoked, the application initiates a swap animation process to transition from one view of a document to a different view of the document. The application may also surface floating command components over content in the document in the different view of the document.

In this manner, an end user may be made aware via the swap animation and the floating command components that the different view is a substantially different type of view than the first view. Such visual hints may remind the user about the temporary nature of the different view and may discourage the user from making formatting mistakes.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational scenario in an implementation.

FIG. 2 illustrates a view transition process in an implementation.

FIG. 3 illustrates an operational scenario in an implementation.

FIG. 4 illustrates an operational scenario in an implementation.

FIG. 5 illustrates a software architecture in an implementation.

FIG. 6 illustrates a view transition process in an implementation.

FIG. 7 illustrates an operational sequence in an implementation.

FIG. 8 illustrates a computing system suitable for implementing any of the applications, architectures, services, processes, and operational scenarios disclosed herein with respect to FIGS. 1-7 and discussed below in the Technical Disclosure.

### TECHNICAL DISCLOSURE

Enhanced view transition technology disclosed herein includes a dual-view entrance/exit animation and multi-color floating user interface that enables users to seamlessly switch between at least two editable modes, yet assures users that the secondary reflowed layout is temporary and layout changes made within this view are not page-based. The user interface also allows users to quickly exit out of the secondary mode without exiting the actual document.

Microsoft® Word® for the iPhone® is one example of a mobile word processing application that enables users to seamlessly switch between two distinct editable environments known as “fit-to-page” (Page Layout View) and “fit-to-screen” (Reflow View). However, this presents various design challenges as the “fit-to-screen” view reflows the entire document content to fit within the screen (such that users no longer have to “pan and scan”). This can give users the misimpression that the reflow view has altered document content. Secondly users who are within the reflow view for extended periods of time may make formatting choices that do not “stick” or that override formatting choices that were made in the print layout view.

Implementations of enhanced view transition technology disclosed herein address these concerns with a dual-view entrance/exit animation and multi-color floating commanding system. A technical effect that may be appreciated in this design includes an enhanced user experience. Users will know that they have entered an optimized yet temporal environment, as opposed to getting the impression that they have permanently reformatted their document.

This is accomplished by ensuring that the user interface between two views are distinct, such that even after an extended period of time reading and editing within a Reflow View users remain aware that they are in this temporal environment (so as to not make editing changes based on “virtual” screen metrics). In addition, the in-between animation is a “swap-based” animation, as opposed to “morph.” Lastly, there is the multi-color heads-up-display button system to ensure a quick visual key to exit.

In an implementation, the mode-switching animation is a “swap-based” animation, as opposed to “morph.” After the “swap” animation is performed, a multi-color floating command system is animated. In the event the user hits the Back button in the virtual view (e.g., Reflow View), the application purposefully exits out of the virtual view with a reverse dual-view animation, only after which the application closes the document and take the user to their document library.

The application uses floating buttons, as opposed to traditional persistent “chrome,” to underscore the fact that the user is in a virtual mode. The multi-color floating user interface system gives prominence to the exit button such that users know that the entrance/exit is in close proximity and to avoid users hitting the Back Button, which would inadvertently close the document altogether, as opposed to exit the virtual mode.

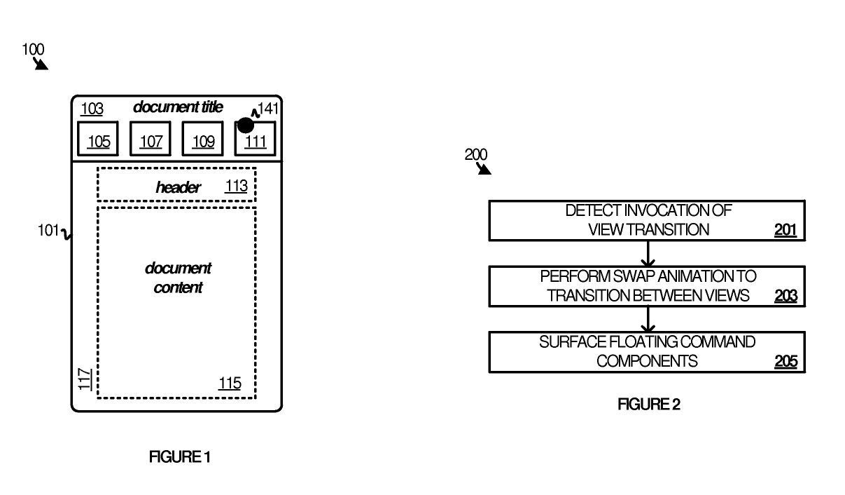

FIG. 1 illustrates an operational scenario 100 in an implementation to demonstrate various aspects of the enhanced transition technology disclosed herein. Operational scenario 100 includes a view 101 of a document that may be presented by an application executing on a computing system, such as a mobile phone, smart phone, tablet, phablet, or the like, of which computing system 801 is representative. Examples of documents include, but are not limited to, word processing documents, spreadsheet workbooks, and presentation slide decks.

View 101 of the document includes a space 103 for a document title, various menu buttons 105, 107, 109, and 111, a space 113 that may include a header, another space 115 that may include document content, and yet another space 117 that may represent a boundary or margins for the document.

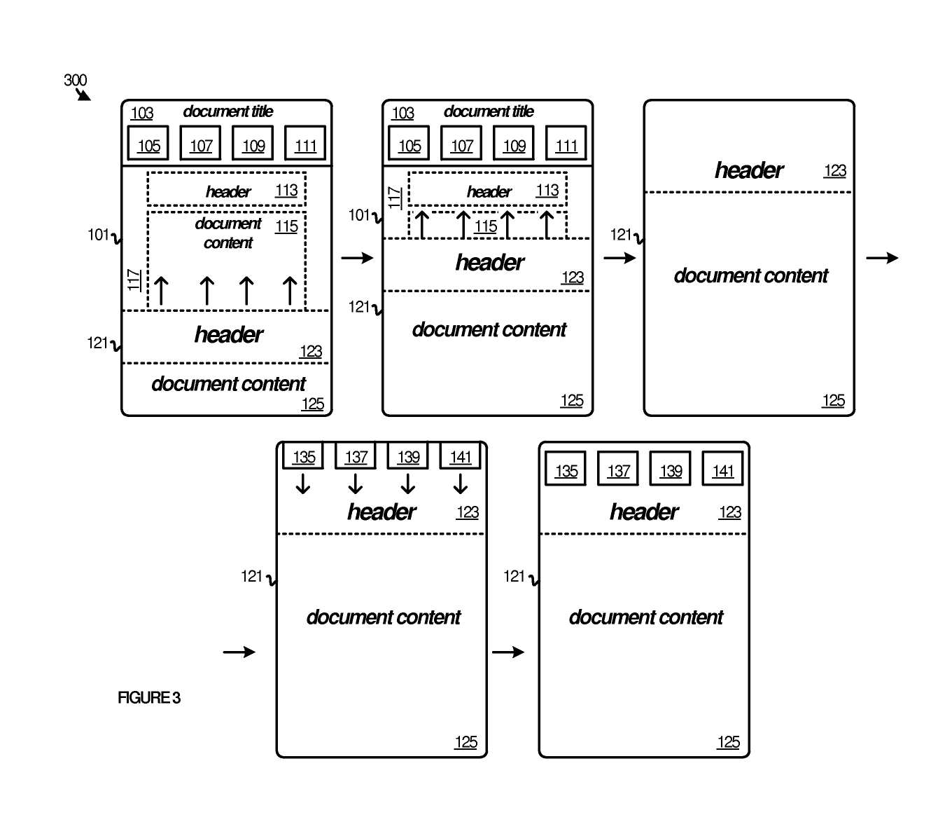

A user may interact with view 101 in various ways. In the background, the application employs a view transition process, of which view transition process 200 illustrated in FIG. 2 is representative. Referring parenthetically to the steps illustrated in FIG. 2, the application monitors for when a user may select menu button 111, for example, to switch out of view 101 and into a different view of the document.

Upon detecting an invocation of a view transition as described above (step 201), view transition process 200 drives the application to perform a swap animation to transition between one view and another view (step 203). In this example, the application transitions from view 101 to view 121. The swap animation is illustrated in more detail in FIG. 3. Upon performing the swap animation, the application is driven to surface floating command components in view 121 (step 205)

Referring now to FIG. 3, operational scenario 300 presents a more detailed illustration of the swap animation and floating command renderings. In operation, view 121 is presented in a swap style, such that it looks like view 101 is swapped out for view 121. This is accomplished by introducing view 121 from the bottom of view 101, although it may be introduced from other directions.

As view 121 progresses to encompass view 101, the components in view 101 are replaced with those found in view 121. Thus, space 115, space 113, and space 117 are eventually covered up by, or swapped for, space 123 and space 125. In addition, space 103 is removed entirely and is not replaced with any other space. What remains is simply space 125 and space 123. It may be appreciated that the format and styling of the text in both spaces differs relative to the formatting and styling of the text in view 101.

Next, floating command buttons are introduced in the animation. Buttons 135, 137, 139, and 141 are “floated down” from the top of view 121, although they may be introduced from other directions. The buttons float over space 123. As such, they appear as though they are in the document, as opposed to in a separate menu outside of the document.

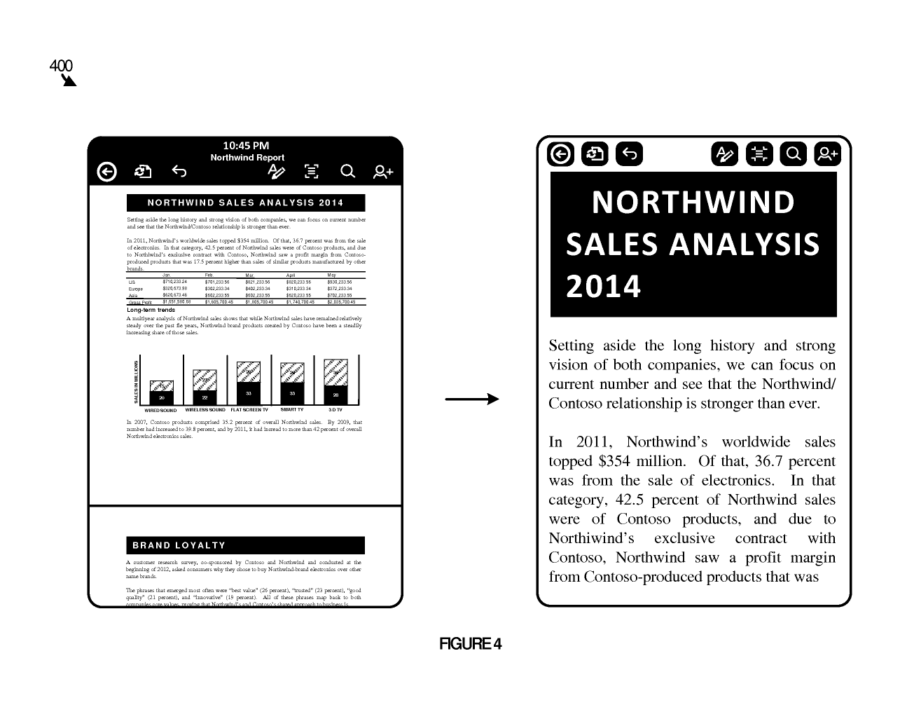

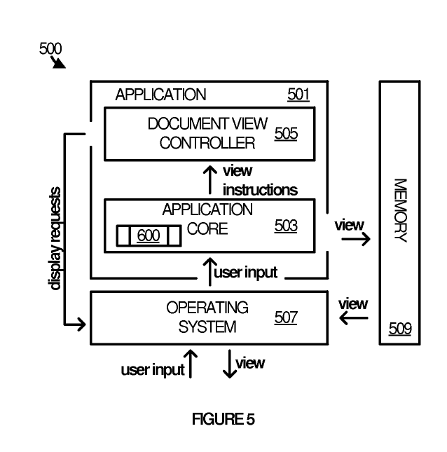

FIG. 4 illustrates an operational scenario 400 that swaps view 401 for view 403, per the animation discussed above with respect to FIGS. 1-3. View 401 is representative of a fit-to-page view, while view 403 is representative of a fit-to-screen view. In view 401, text, images, and other content appear in their true format, while in view 403, the formatting of the content may appear to be different from that in view 401. To reduce the likelihood that the user mistakes the formatting as an error, the swap animation occurs and floating command buttons are introduced. Such visual clues may remind the user to refrain from attempting to unnecessarily fix the formatting.

FIG. 500 illustrates a software architecture 500 that may be employed by a computing device to carry out some of the processes and operational scenarios disclosed herein. Computing system 801 is representative of a device that may be suitable for employing software architecture 500.

Software architecture 500 includes application 501, operating system 507, and memory 509. Application 501 includes application core 503 and document view controller 505. Application core 503 is representative of any application component, module, or other arrangement of program instructions capable of implementing view transition process 600.

In operation, user input may be received via a user interface system and communicated to operating system 507. Operating system 507 makes application core 503 aware of the user input so that application core 503 can apply application logic in response.

In some cases, the user input prompts application core 503 to communicate view instructions to document view controller 505. Depending on what the view instructions are, document view controller 505 may communicate display requests to operating system 507 in order to drive the display of various views in a view hierarchy.

Application core 503 is also capable of rendering the views that document view controller 505 manages. The views are rendered in memory 509, from where operating system 507 obtains the views for display via the aforementioned user interface system.

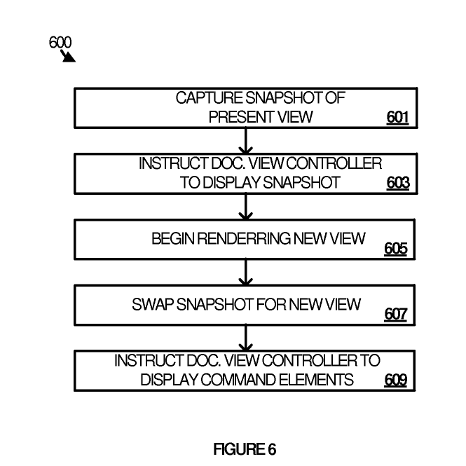

Application core 503 employs view transition process 600 as part of its application logic. The steps involved in view transition process 600 are illustrated in FIG. 6, a description of which follows with parenthetical reference to the steps.

When a user invokes a view transition to transition from one view of a document to another, such as by clicking on, touching, or otherwise selecting a navigational element (e.g. button), application core 503 captures a snapshot of the present view of a document that is displayed on a screen (step 601). The capture may be a screen capture of the whole image displayed on the screen. The screen capture is just an image, whereas a view is a software object or collection of objects. A captured image is therefore a simpler data structure than a view.

After capturing the snapshot, application core 503 instructs document view controller 505 to display the snapshot of the document on the screen (step 603). Document view controller 505, per its own programmed logic, immediately communicates a request to operating system 507 to display the snapshot in place of the initial view that had been displayed. As the snapshot is visually the same as the view, no change will have occurred from the user's perspective, even though a different data structure (the snapshot) is now displayed in place of a previous data structure (the initial view).

Application core 503 proceeds to render a new, or subsequent view of the document in memory 509 (step 605). Rendering the subsequent view may include deleting the initial view from memory 509 and creating the subsequent view as a new data structure. Alternatively, rendering the subsequent view may involve writing over the data in the initial view. In either case, one view is replaced by the other in memory 509, which has the technical effect of removing the initial view from memory 509. Maintaining one view in memory 509, instead of multiple views, has the technical effect of conserving memory 509.

Once the new view is rendered in memory 509, it can be swapped for the snapshot (step 607). Application core 503 proceeds to request document view controller 505 to display the new view in place of the snapshot. As mentioned above, this may be accomplished by a swap animation. The swap animation itself may be accomplished by progressively reducing the snapshot while correspondingly enlarging the new view. Such an animation may give the visual effect of the snapshot receding or falling away while the new view comes into visual prominence on the screen. Reducing the size of the snapshot may be accomplished by application core 503 changing its parameters, such as by reducing the dimensions of its shape. Alternatively, document view controller 505 could reduce its dimensions.

The dimensions of the snapshot could be reduced by either application core 503 or document view controller 505 making repeated or iterative calls to operating system 507 informing operating system 507 of the dimension changes. The dimension changes would then be handled by operating system 507 as each call is made. In the aggregate, the changes would give the visual effect to the user of the snapshot shrinking while the new view encompasses the space in the user interface vacated by the snapshot.

Lastly, application core 503 instructs document view controller 505 to display command elements (step 609). Document view controller 505 responsively communicates with operating system 507 and the command elements are dropped into the user interface.

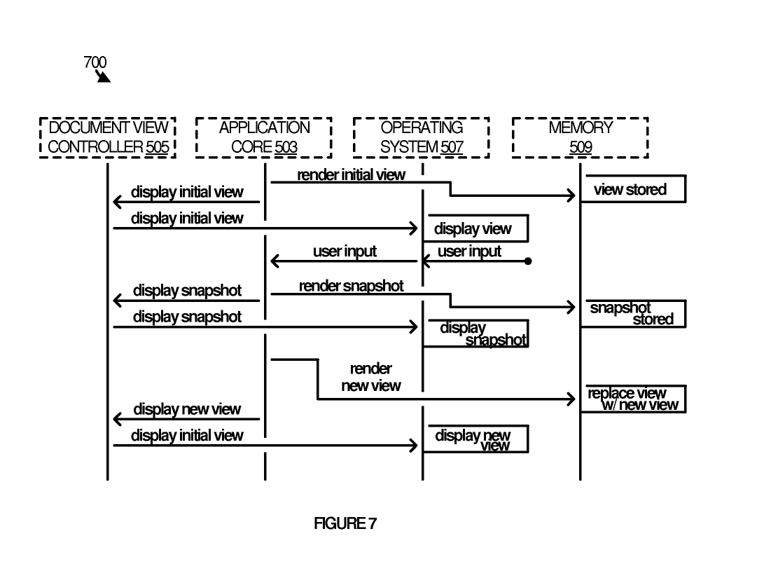

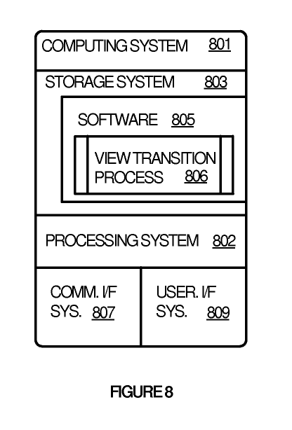

FIG. 7 illustrates an operational sequence 700 to further illustrate various principles of the enhanced view transition technology contemplated herein. In operation, application core 503 renders an initial view of a document in memory 509, where it is stored. Application core 503 also requests document view controller 505 to display the initial view of the document in a user interface. Document view controller 505 responsively communicates with operating system 507 to display the view. Operating system 507 then drives a user interface system to display the initial view on a screen.

User input may then be received via the user interface system. Operating system 507 is made aware of the user input and informs application core 503 of the user input. In this example sequence, it is assumed for illustrative purposes that the user input is a selection of a button, link, or some other navigation element that takes that triggers a transition from the initial view of the document to a different view.

In response to the user input, application core 503 captures a snapshot of what is presently displayed on the screen, which is the initial view. The snapshot is stored in memory 509. Application core 503 instructs document view controller 505 to display the snapshot. Document view controller 505 then communicates a display request to operating system 507, which then drives the user interface system to display the snapshot.

While the snapshot is displayed, application core 503 begins to render the new view of the document. The new view replaces the initial view in memory 509, which conserves memory space. Once the new view is rendered, application core 503 instructs document view controller 505 to display the new view in place of the snapshot. Document view controller 505 then communicates with operating system 507 to swap out the snapshot for the new view. As mentioned, this may be accomplished by progressively reducing the size of the snapshot and introducing the new view in the space vacated by the snapshot.

FIG. 8 illustrates computing system 801 that is representative of any system or collection of systems in which the various operational architectures, scenarios, and processes disclosed herein may be implemented. Examples of computing system 801 include, but are not limited to, smart phones, laptop computers, tablet computers, desktop computers, hybrid computers, gaming machines, virtual machines, smart televisions, smart watches and other wearable devices, as well as any variation or combination thereof. In other examples, other types of computers may be involved in the processes, including server computers, rack servers, web servers, cloud computing platforms, and data center equipment, as well as any other type of physical or virtual server machine, and any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes at least view transition process 806, which is representative of the view transition processes discussed with respect to the preceding FIGS. 1-7, including view transition process 200, view transition process 600, and the processes embodied in the operational scenarios and sequences described herein. View transition process 806 may be implemented in the context of an application or group of applications, of which application 501 in FIG. 5 is representative.

When executed by processing system 802 to enhance view transition capabilities, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for implementing enhanced view transitions and related functionality.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software or other application software, in addition to or that include view transition process 806, of which application 501 and operating system 507 in FIG. 5 are representative. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced view transitions. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

It may be understood that computing system 801 is generally intended to represent a computing system or systems on which software 805 may be deployed and executed in order to implement enhanced view transitions. However, computing system 801 may also be suitable as any computing system on which software 805 may be staged and from where it may be distributed, transported, downloaded, or otherwise provided to yet another computing system for deployment and execution, or yet additional distribution.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface capable of presenting views and presenting transitions between views as discussed herein.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

While FIGS. 1-8 generally depict relatively few users and relatively few instances of computing systems and applications, it may be appreciated that the concepts disclosed herein may be applied at scale. For example, the view transition processes disclosed herein could be deployed in support of any number of devices, users, data, applications, and instances thereof.

Certain inventive aspects may be appreciated from the foregoing disclosure, of which the following are various examples.

### EXAMPLE 1

An apparatus comprising: a storage system that stores program instructions comprising an application; a processing system operatively coupled to the storage system and capable of loading and executing the application, wherein the processing system, when executing the application, is directed by the application to at least: present a user interface to the application in which to present views of documents; when a view transition is invoked through the user interface to transition from an initial view of a document to a subsequent view of the document, present a snapshot of the initial view of the document in the user interface; while the snapshot of the initial view of the document is maintained, render the subsequent view of the document; and present the subsequent view of the document in place of the snapshot of the initial view of the document.

### EXAMPLE 2

The apparatus of Example 1 wherein the application further directs the processing system to, after the subsequent view of the document is presented, present a plurality of command components in a floating manner above the subsequent view of the document.

### EXAMPLE 3

The apparatus of Examples 1-2 wherein to present the subsequent view in place of the snapshot, the application directs the processing system to progressively shrink the snapshot and conespondingly enlarge the subsequent view.

### EXAMPLE 4

The apparatus of Examples 1-3 wherein the snapshot of the initial view of the document comprises a screen capture of the initial view of the document and wherein the application further directs the processing system to remove the initial view of the document from memory after generating the screen capture and before rendering the subsequent view of the document.

### EXAMPLE 5

The apparatus of Examples 1-4 wherein the application further directs the processing system to replace the initial view of the document in memory with the subsequent view of the document when the snapshot of the initial view of the document is captured.

### EXAMPLE 6

The apparatus of Examples 1-5 wherein the application comprises an application core and a document view controller and wherein to present the snapshot of the initial view of the document, the application core directs the processing system to capture the snapshot and to instruct the document view controller to display the snapshot in place of the initial view of the document.

### EXAMPLE 7

The apparatus of Examples 1-6 wherein to present the subsequent view in place of the snapshot, the document view controller directs the processing system to progressively shrink the snapshot and correspondingly enlarge the subsequent view.

### EXAMPLE 8

The apparatus of Examples 1-7 wherein to present the subsequent view in place of the snapshot, the application core directs the processing system to progressively shrink the snapshot and correspondingly enlarge the subsequent view.

### EXAMPLE 9

The apparatus of Examples 1-8 wherein the initial view of the document comprises a fit-to-page view of the document and wherein the subsequent view of the document comprises a fit-to-screen view of the document.

### EXAMPLE 10

The apparatus of Examples 1-9 wherein the document comprises one of a word processing document, a spreadsheet workbook, and a presentation slide deck.

### EXAMPLE 11

An apparatus comprising: one or more computer readable storage media; and program instructions stored on the one or more computer readable storage media and comprising an application that, when executed by a processing system, directs the processing system to at least: detect when a view transition is invoked; when the view transition is invoked, initiate a swap animation process to transition from one view of a document to a different view of the document; and surface floating command components over content in the document in the different view of the document.

### EXAMPLE 12

The apparatus of Example 11 further comprising the processing system operatively coupled with the one or more computer readable storage media, wherein the processing system reads and executes the program instructions, and wherein the document comprises one of a word processing document, a spreadsheet workbook, and a presentation slide deck.

### EXAMPLE 13

A method for transitioning between views of documents, the method comprising: presenting a user interface to an application in which to present the views; when a view transition is invoked through the user interface to transition from an initial view of a document to a subsequent view of the document, presenting a snapshot of the initial view of the document in the user interface; while the snapshot of the initial view of the document is maintained, rendering the subsequent view of the document; and presenting the subsequent view of the document in place of the snapshot of the initial view of the document.

### EXAMPLE 14

The method of Example 13 further comprising, after presenting the subsequent view of the document, presenting a plurality of command components in a floating manner above the subsequent view of the document.

### EXAMPLE 15

The method of Examples 13-14 wherein presenting the subsequent view in place of the snapshot comprises progressively shrinking the snapshot and correspondingly enlarging the subsequent view.

### EXAMPLE 16

The method of Examples 13-15 wherein the snapshot of the initial view of the document comprises a screen capture of the initial view of the document and wherein the method further comprises removing the initial view of the document from memory after generating the screen capture and before rendering the subsequent view of the document.

### EXAMPLE 17

The method of Examples 13-16 wherein the method further comprises replacing the initial view of the document in memory with the subsequent view of the document when the snapshot of the initial view of the document is captured.

### EXAMPLE 18

The method of Examples 13-17 wherein the application comprises an application core and a document view controller and wherein the method comprises the application core capturing the snapshot and instructing the document view controller to present the snapshot in place of the initial view of the document.

### EXAMPLE 19

The method of Examples 13-18 wherein presenting the subsequent view in place of the snapshot comprises the document view controller progressively shrinking the snapshot and correspondingly enlarging the subsequent view.

### EXAMPLE 20

The method of Examples 13-19 wherein the initial view of the document comprises a fit-to-page view of the document, wherein the subsequent view of the document comprises a fit-to-screen view of the document, and wherein the document comprises one of a word processing document, a spreadsheet workbook, and a presentation slide deck.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. An apparatus comprising:
a storage system that stores program instructions comprising an application;
a processing system operatively coupled to the storage system and capable of loading and executing the application, wherein the processing system, when executing the application, is directed by the application to at least:
present a user interface to the application in which to present views of documents;
when a view transition is invoked through the user interface to transition from an initial view of a document to a subsequent view of the document, present a snapshot of the initial view of the document in the user interface;
while the snapshot of the initial view of the document is maintained, render the subsequent view of the document; and
present the subsequent view of the document in place of the snapshot of the initial view of the document.

2. The apparatus of claim 1 wherein the application further directs the processing system to, after the subsequent view of the document is presented, present a plurality of command components in a floating manner above the subsequent view of the document.

3. The apparatus of claim 1 wherein to present the subsequent view in place of the snapshot, the application directs the processing system to progressively shrink the snapshot and correspondingly enlarge the subsequent view.

4. The apparatus of claim 3 wherein the snapshot of the initial view of the document comprises a screen capture of the initial view of the document and wherein the application further directs the processing system to remove the initial view of the document from memory after generating the screen capture and before rendering the subsequent view of the document.

5. The apparatus of claim 1 wherein the application further directs the processing system to replace the initial view of the document in memory with the subsequent view of the document when the snapshot of the initial view of the document is captured.

6. The apparatus of claim 1 wherein the application comprises an application core and a document view controller and wherein to present the snapshot of the initial view of the document, the application core directs the processing system to capture the snapshot and to instruct the document view controller to display the snapshot in place of the initial view of the document.

7. The apparatus of claim 6 wherein to present the subsequent view in place of the snapshot, the document view controller directs the processing system to progressively shrink the snapshot and correspondingly enlarge the subsequent view.

8. The apparatus of claim 6 wherein to present the subsequent view in place of the snapshot, the application core directs the processing system to progressively shrink the snapshot and correspondingly enlarge the subsequent view.

9. The apparatus of claim 1 wherein the initial view of the document comprises a fit-to-page view of the document and wherein the subsequent view of the document comprises a fit-to-screen view of the document.

10. The apparatus of claim 1 wherein the document comprises one of a word processing document, a spreadsheet workbook, and a presentation slide deck.

11. An apparatus comprising:
one or more computer readable storage media; and
program instructions stored on the one or more computer readable storage media and comprising an application that, when executed by a processing system, directs the processing system to at least:
detect when a view transition is invoked;
when the view transition is invoked, initiate a swap animation process to transition from one view of a document to a different view of the document; and
surface floating command components over content in the document in the different view of the document.

12. The apparatus of claim 11 further comprising the processing system operatively coupled with the one or more computer readable storage media, wherein the processing system reads and executes the program instructions, and wherein the document comprises one of a word processing document, a spreadsheet workbook, and a presentation slide deck.

13. A method for transitioning between views of documents, the method comprising:
presenting a user interface to an application in which to present the views;
when a view transition is invoked through the user interface to transition from an initial view of a document to a subsequent view of the document, presenting a snapshot of the initial view of the document in the user interface;
while the snapshot of the initial view of the document is maintained, rendering the subsequent view of the document; and
presenting the subsequent view of the document in place of the snapshot of the initial view of the document.

14. The method of claim 13 further comprising, after presenting the subsequent view of the document, presenting a plurality of command components in a floating manner above the subsequent view of the document.

15. The method of claim 13 wherein presenting the subsequent view in place of the snapshot comprises progressively shrinking the snapshot and correspondingly enlarging the subsequent view.

16. The method of claim 15 wherein the snapshot of the initial view of the document comprises a screen capture of the initial view of the document and wherein the method further comprises removing the initial view of the document from memory after generating the screen capture and before rendering the subsequent view of the document.

17. The method of claim 13 wherein the method further comprises replacing the initial view of the document in memory with the subsequent view of the document when the snapshot of the initial view of the document is captured.

18. The method of claim 13 wherein the application comprises an application core and a document view controller and wherein the method comprises the application core capturing the snapshot and instructing the document view controller to present the snapshot in place of the initial view of the document.

19. The method of claim 18 wherein presenting the subsequent view in place of the snapshot comprises the document view controller progressively shrinking the snapshot and correspondingly enlarging the subsequent view.

20. The method of claim 13 wherein the initial view of the document comprises a fit-to-page view of the document, wherein the subsequent view of the document comprises a fit-to-screen view of the document, and wherein the document comprises one of a word processing document, a spreadsheet workbook, and a presentation slide deck.
